(19) United States
(12) Patent Application Publication
(10) Pub. No.: US 2017/0283340 A1
(43) Pub. Date: Oct. 5, 2017

(54) ALKYL THIOPHOSPHORIC TRIAMIDE AND NEEM OIL SOLVENT SYSTEMS FOR USE IN AGRICULTURAL APPLICATIONS

(71) Applicant: RHODIA OPERATIONS, Paris (FR)

(72) Inventors: Nilesh PATIL, Maharashtra (IN); Krish SHANMUGA, Plainsboro, NJ (US)

(73) Assignee: RHODIA OPERATIONS, Paris (FR)

(21) Appl. No.: 15/478,475

(22) Filed: Apr. 4, 2017

Related U.S. Application Data
(60) Provisional application No. 62/317,682, filed on Apr. 4, 2016.

(51) Int. Cl. C05G 3/08; C09K 15/34; C05C 11/00

(52) U.S. Cl. CPC C05G 3/08; C05C 11/00; C09K 15/34

(57) ABSTRACT

An inhibitor composition contains a urease inhibitor (e.g., alkyl thiophosphoric triamide) and a nitrification inhibitor (e.g., a natural nitrification inhibitor such as neem oil and the like), solubilized in a liquid medium comprising at least one organic solvent and, optionally, at least one stabilizer, useful in making fertilizer compositions (e.g., urea prill coatings) and in methods of fertilizing target plants.

### CROSS-REFERENCE TO RELATED APPLICATIONS

This application claims the benefit of U.S. Provisional Application Serial No. 62/317,682, filed Apr. 4, 2016, incorporated herein by reference in its entirety.

### FIELD OF THE INVENTION

This invention relates to liquid compositions comprising nitrification inhibitors and/or urease inhibitors, as well as related methods, and more particularly, for urease inhibitors and/or natural nitrification inhibitors such as neem and neem oil.

### BACKGROUND OF THE INVENTION

In the agrochemical industry, farmers use various fertilizers to impart macronutrients to plants either by application to the soil or application to plant leaves. Nitrogen, phosphorus, potassium, calcium, magnesium, and sulfur are macronutrients that must be supplied to the plants and soil manually by farmers. In many crops, the amount of nitrogen supplied is critical to the overall quality and growth of the crop. Nitrogen is typically supplied in the form of nitrogenous, i.e., nitrogen precursor-containing, fertilizer compounds, such as urea, ammonium nitrate, or ammonium phosphate fertilizer compounds. Due to the high water solubility of these salts, however, applied nitrogen values may be lost due to run-off and leaching of the nitrogenous fertilizer compounds. Once applied, the nitrogenous fertilizer compounds are typically degraded, for example, by microorganisms present in the soil, to nitrogenous species such as NH₄⁺, NO₂⁻, NO₃⁻, and ammonia gas, that may be even more readily lost through evaporation, run-off, and leaching than the fertilizer compounds themselves. If degradation of the fertilizer compounds occurs at a rate that is faster than the nitrogenous degradation products can be used by the plants, then the nitrogen values in the degradation products are at increased risk of being lost.

Nitrification and/or urease inhibitors are of potential use in delaying degradation of fertilizer compounds and thereby reducing losses of nitrogenous degradation products that would otherwise occurred in the absence of the inhibitors. The use of nitrification and/or urease inhibitors in combination with nitrogenous fertilizer compounds tends to increase the amount of time the nitrogen source remains in the soil and available for absorption by the plants, which tends to increase the effectiveness of the fertilizer and positively impact crop yield and quality.

Aqueous end use fertilizer solutions are typically prepared in the field by diluting commercially available concentrated fertilizer compositions with water. Commonly used concentrated fertilizer compositions include concentrated ammonium nitrate compositions, such as, for example, UAN 18, UAN 28, UAN 30 and UAN 32.

There are, however, problems with nitrification and urease inhibitors in such aqueous end use fertilizer compositions, as generally these inhibitors have very low miscibility/solubility in water. Thus they are difficult to incorporate into aqueous end use fertilizer compositions, particularly under field conditions.

### SUMMARY OF THE INVENTION

Fertilizers, in one embodiment, are common water soluble inorganic fertilizers that provide nutrients such as phosphorus-based, nitrogen-based, potassium-based or sulphur-based fertilizers. Examples of such fertilizers include: for nitrogen as the nutrient: nitrates and or ammonium salts such as ammonium nitrate, including in combination with urea e.g. as Uram type materials, calcium ammonium nitrate, ammonium suphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride. It is understood that a fertilizer composition can comprise one or a combination of the fertilizers described herein.

Urease inhibitors can be used with a fertilizer (i.e., incorporated into a urea-containing fertilizer, e.g., urea and urea ammonium nitrate (UAN)) to slow the conversion of ammonium to ammonia gas and thus slow the loss of ammonia to volatilization, thus making ammonium available to plants in the soil for longer periods of time. In many crops, the amount of nitrogen supplied is critical to the overall quality and growth of the crop. Nitrogen is supplied in either urea or ammonium phosphate forms. Due to the high water solubility of these salts, however, much of the nitrogen applied is lost to run-off and leaching. In ammonium-based products, if the nitrogen is not lost to leaching or run-off, it is being converted to ammonia gas by an enzyme called urease where the ammonia can bind to soil particles. Conversion occurring near the surface of the soil, however, does not allow for binding and this ammonia is lost to the atmosphere. Urease inhibitors are used to protect a farmer's investment in fertilizers by preventing the breakdown of urea by urease, the soil microbe responsible for converting urea to usable ammonia in the soil. This increases the amount of time the nitrogen remains in the soil and is available to the plant for absorption.

A typical urease inhibitor, alkyl thiophosphoric triamide (for example, N-(n-butyl)-thiophosphoric triamide or otherwise “NBPT”), however, faces drawbacks in its use as NBPT is extremely difficult to handle. NBPT is a sticky, waxy, heat and water sensitive material, which cannot be used in its solid form, as it is used at low concentrations making it difficult to evenly distribute on urea prills (i.e., large granules) and in soil. In order to evenly distribute the NBPT onto the urea, the NBPT should be dispersed into a carrier prior to being sprayed onto the urea. Thus, the use of a solvent system containing the NBPT is desirable as, in its liquid form, the solvent system is capable of distributing the NBPT into granular urea (e.g., urea prills) and into liquid fertilizers containing urea. By introducing the NBPT to liquid fertilizers containing urea (for example, urea-ammonium nitrate solutions or UAN) in a solvent system, the NBPT is capable of being better dispersed in the liquid fertilizer.

Other urease inhibitors can include N-(n-Butyl) thiophosphoric triamide (NBTPT or NBPT), N-(n-Butyl) phosphoric triamide (NBPTO or BNPO), phenylphosphorodiamidate (PPD/PPDA), hydroquinone or ammonium thiosulfate.

In one embodiment, the urease inhibitor is a (thio)phosphoric acid triamide (T) according to the general formula (I)

R1R2N—P(X)(NH2)2 (I)

wherein X is oxygen or sulfur; R1 is an aryl, an alkyl, a cycloalkyl, or a dialkylaminocarbonyl group; and R2 is H or an alkyl group. In another embodiment, R1 is a C1 to C30 alkyl or C3 to C30 cycloalkyl. In another embodiment, R1 and R2 together with the linking nitrogen atom make a 5- or 6-membered saturated or unsaturated heterocyclic radical, which can optionally comprise heteroatoms selected from oxygen, nitrogen or sulfur.

Similarly, nitrification inhibitors can be used with a fertilizer (i.e., incorporated into a urea-containing fertilizer, e.g., urea and urea ammonium nitrate (UAN)) to slow the process of ammonium conversion to nitrate, and subsequently the loss of nitrate to leeching, thus making ammonium available to plants in the soil for longer periods of time. Ammonium is one of the main forms of nitrogen that can be utilized by plants. Increasing the amount of time that the nitrogen is available to the plant increases the effectiveness of the fertilizer which positively impacts crop yield and quality.

Non limiting examples of nitrification inhibitors include but are not limited to, dicyandiamide, sodium thiosulfate (ST), 2-chloro-6-trichloromethylpyridine, 3,4-dimethylpyrazole phosphate, 3-methylpyrazole (MP); 1-H-1,2,4-triazole (TZ); 3-methylpyrazole-1-carboxamide (CMP); 4-amino-1,2,4-triazole; 3-amino-1,2,4-triazole; 2-cyanimino-4-hydroxy-6-methylpyrimidine (CP); 2-ethylpyridine; N-2,5-dichlorophenyl succinanilic acid (DCS), ammonium thiosulfate; thiophosphoryl triamide; thiourea (TU); guanylthiourea (GTU); ammonium polycarboxilate; ethylene urea; hydroquinone; phenylacetylene; phenylphosphoro diamidate; neem; calcium carbide; 5-ethoxy-3-trichloromethyl-1,2,4-thiadiazol (etridiazol; terraole); 2-amino-4-chloro-6-methylpyrimidine (AM); 1-mercapto-1,2,4-triazole (MT); 2-mercaptobenzothiazole; 2-sulfanilam idothiazole (ST); 5-amino-1,2,4-thiadiazole; 2,4-diamino-6-trichloromethyl-s-triazine (CL-1580); nitroaniline, and chloroaniline.

Natural nitrification inhibitors include neem, including neem oil, neem cake and neem powder; koronivia, including koronivia grass; karanj, including karanjin seed extract and karanj oil; mint, including mint oil; and any combination thereof.

Neem oil, containing azadirachtin, may be extracted or mechanically pressed from need seends. Specifically, neem oil can be mechanically pressed from neem seeds in the cold by using oil presses or may be extracted using alcohols or other solvents using a Soxhlet apparatus. Small amounts of neem oil can be obtained by kneading neem seed powder by hand after adding some water. Neem seeds consist of two parts, a shell that does not contain oil or insecticidal activity and the kernel which contains oil and azadirachtin.

Nitrification inhibitors, such as dicyandiamide, generally have very low solubility (about 41 grams per liter (“g/l”) in water and so it is difficult to incorporate into the aqueous end use fertilizer compositions, particularly under field conditions. Other oil or liquid based nitrification inhibitors, such as neem oil, likewise generally have very low miscibility in water and so it is difficult to incorporate into the aqueous end use fertilizer compositions, particularly under field conditions.

As nitrification inhibitors, such as neem oil and DCD, well as urease inhibitors such as NBPT, have a generally low solubility/miscibility, they are used at low concentrations in water making it difficult to evenly distribute on urea-containing prills (i.e., large granules) and in soil. In order to evenly distribute the at least one nitrification inhibitor and/or at least one urease inhibitor onto the urea-containing prills or granules, the nitrification inhibitor(s) and/or urease inhibitor(s) should be dispersed or solubilized into a solvent carrier or solvent system prior to being sprayed onto the urea.

Thus, the use of a composition/solvent system containing at least one nitrification inhibitor, at least one urease inhibitor, or a combination of (i) at least one nitrification inhibitor and (ii) at least one urease inhibitor, is desirable to coat onto urea granules or prills, urea ammonium nitrate granules or prills or, otherwise, urea-containing granules or prills, and into liquid fertilizers containing urea or urea ammonium nitrate. By introducing the nitrification inhibitor and/or urease inhibitor to liquid fertilizers containing urea (for example, urea-ammonium nitrate solutions or UAN) in a solvent system, the nitrification inhibitor and/or urease inhibitor is capable of being better dispersed in the liquid fertilizer.

In one embodiment, concentrated fertilizer compositions include concentrated ammonium nitrate compositions, such as, for example, UAN 18, UAN 28, UAN 30 and UAN 32.

In one embodiment, it is also desirable to have a solvent system containing the nitrification inhibitor and/or urease inhibitor to have a favorable toxicological and/or ecological profile and desirable characteristics in terms of low volatility, biodegradability or ready biodegradability (i.e., readily biodegradable), low toxicity or low hazard level or any combination thereof. It is desirable, in another embodiment, to have a solvent system containing at least one nitrification inhibitor and/or urease inhibitor, wherein at least one nitrification inhibitor is a natural nitrification inhibitor, that has a favorable toxicological and/or ecological profile and desirable characteristics in terms of low volatility, biodegradability or ready biodegradability (i.e., readily biodegradable), low toxicity or low hazard level.

Another problem is that certain nitrification inhibitors and/or urease inhibitors degrade at certain high temperatures. For example, NBPT—a urease inhibitor—degrades rapidly at higher temperature, typically, above 45° C. Often times temperatures in agricultural fields (e.g., corn fields, wheat fields, etc.) reach in excess of 35° C. and sometimes can reach up to 45° C. or higher. For example, at 45° C. NBPT formulated in different solvents changes color in days from colorless to a darker green/brown, followed by sludge/precipitate formation after weeks had been exposed to high heat. Thus, it is also desirable to have solvent systems containing nitrification inhibitors and/or urease inhibitors that are stabilized at high temperatures, such as those utilized in hot climates or weather. This invention addresses the addition of co-solvents and/or stabilizers to prolong the chemical and physical stability of formulated liquid agricultural compositions containing (i) one or more nitrification inhibitors, (ii) one or more urease inhibitors or (iii) a combination of both (i) and (ii). In one embodiment, the at least one urease inhibitor is NBPT. In one embodiment, the at least one nitrification inhibitor a natural nitrification inhibitor. In yet another embodiment, the at least one nitrification inhibitor is neem.

The present invention described herein will become apparent from the following detailed description and examples, which comprises in one aspect, a liquid composition for use in agricultural applications comprising: at least one of a nitrification inhibitor and/or a urease inhibitor; and at least one solvent.

In one aspect, described herein are stable liquid agricultural composition comprising
at least one nitrification inhibitor;
at least one solvent selected from:
   (a) at least one dioxolane compound of formula (I.b):

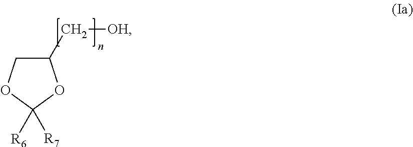

wherein R₆ and R₇ individually comprises a hydrogen, an alkyl group, an alkenyl group, or a phenyl group, wherein n is an integer of from 1 to 10; b) at least one dibasic ester; c) at least one compound of formula (III):

R₃OOC-A-CONR₄R₅ (III)

wherein R₃ comprises a C₁—C₃₆ alkyl group; wherein R₄ and R₅ individually comprise a C₁—C₃₆ alkyl group, wherein R₄ and R₅ can optionally together form a ring; and wherein A is a linear or a branched divalent C₂—C₆ alkyl group; d) at least one alkyldimethylamide; e) at least one alkyl lactate; f) ethyl levulinate; g) at least one alkyoxyalcohol, ether alcohol, amine alcohol, amino alcohol or alcohol; h) at least one glycol, glycol derivative, glycerine or glycerine derivative; i) at least one alkylene carbonate; j) dimethylsulfoxide; k) an amine selected from monoalkanolamine, dialkanolamine, trialkanolamine, monoethanolamine, diethanolamine and triethanolamine; l) a sulfone or sulfolane; m) an aminoalkoxy alcohol; n) cyclohexanone or cyclopentanone; o) benzyl alcohol; or p) any combination thereof, wherein the at least one nitrification inhibitor is dispersed or solubilized in the at least one solvent.

In one embodiment, the at least one nitrification inhibitor is selected from neem, neem oil, neem cake, koronivia grass, karanj, karanjin seed extract, karanj oil, mahua, mahua oil, castor, castor oil, mint, mint oil, or any combination thereof. Typically, the at least one nitrification inhibitor is neem or neem oil.

In one embodiment, the solvent is DMSO. In another embodiment, the solvent is an alkanolamine including but not limited to monoalkanolamine. In another embodiment, the solvent is a dialkanolamine or a trialkanolamine. In yet another embodiment, the solvent is monoethanolamine, diethanolamine, or triethanolamine. In another embodiment, the alkanol group is chosen from methanol, ethanol, propanol, butanol.

In another aspect, described herein are methods of making a solid or concentrated liquid fertilizer compositions comprising treating (e.g., contacting or spray applying) one or more nitrogenous fertilizer compounds with a liquid inhibitor composition. The liquid inhibitor composition comprises at least one of a nitrification inhibitor and/or a urease inhibitor, homogenously solubilized, dissolved or dispersed in a solvent as described herein. The liquid inhibitor composition, in one embodiment, further comprises at least one organic co-solvent selected from polar aprotic solvents, amine solvents, heterocyclic alcohol solvents, and mixtures thereof.

The term treating, in one embodiment, includes spray applying the liquid inhibitor composition with the one or more nitrogenous fertilizer compounds. The term treating, in one embodiment, includes but is not limited to contacting the inhibitor composition with the one or more nitrogenous fertilizer compounds. In one embodiment, the nitrification inhibitor is neem or neem oil. In another embodiment, the urease inhibitor is an alkyl thiophosphoric triamide.

In yet another aspect, described herein are concentrated liquid fertilizer compositions comprising, based on weight of the composition: (a) up to about 99 wt %, by weight of composition, of one or more nitrogenous fertilizer compounds, (b) at least one nitrification inhibitor, at least one urease inhibitor, or a combination of both, (c) a solvent as described herein and (d), optionally, an additional component.

In a further aspect, described herein are concentrated liquid fertilizer compositions comprising, based on weight of the composition: (a) up to about 99 wt %, by weight of composition, of one or more nitrogenous fertilizer compounds, (b) at least one nitrification inhibitor, at least one urease inhibitor, or a combination of both, (c) optionally, at least one organophosphate compound according to formula (I.a), (d) at least one solvent selected from polar aprotic solvents, heterocyclic alcohol solvents, and mixtures thereof, (e) and optionally, water. The concentrated liquid fertilizer compositions can further optionally comprise one or more additives or co-solvents that help to stabilize the composition.

In yet another aspect, described herein are solid or substantially solid fertilizer compositions comprising: (a) solid particles of one or more nitrogenous fertilizer compounds, and (b) at least one nitrification inhibitor, at least one urease inhibitor, or a combination of both, supported (or contacted) on at least a portion of the solid particles.

In another aspect, described herein are methods of making a high/low temperature stable liquid or aqueous fertilizer composition comprising contacting one or more nitrogenous fertilizer compounds, with a liquid inhibitor composition that comprises at least one nitrification inhibitor, at least one urease inhibitor, or a combination of both, homogenously solubilized, dissolved or dispersed in a solvent as described herein. The solvent can, optionally, further comprise an organic co-solvent selected from polar aprotic solvents, amine solvents, heterocyclic alcohol solvents, and mixtures thereof.

In another aspect, described herein are methods for fertilizing target plants, comprising applying an aqueous end use fertilizer composition that comprises: (a) one or more nitrogenous fertilizer compounds, (b) at least one nitrification inhibitor, at least one urease inhibitor, or a combination of both, (c) at least one solvent as described herein. In one embodiment, the at least one solvent comprises dimethyl sulfoxide (DMSO), dimethyl formamide, the dimethyl ester of succinic acid, dimethyl ester of ethyl succinic acid, the dimethyl ester of glutaric acid, the dimethyl ester of methyl glutaric acid, and the dimethyl ester of adipic acid, diethylene triamine, or monoethanolamine, methyl-5-(dimethylamino)-2-methyl-oxopentanoate, dimethylaminoethanol, triethanol amine, a heterocyclic alcohol according to formula (II.a):

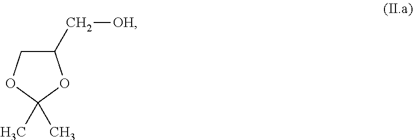

or mixtures thereof, (d) an amine alcohol, and optionally, (e) water, to the target plants or to an environment for the target plants. It is understood that the term heterocyclic alcohol includes dioxolane compounds.

In another aspect, the present invention is directed to a nitrification inhibitor composition comprising neem or neem oil solubilized in a liquid medium that comprises an organic solvent selected from polar aprotic solvents, dibasic esters, amines, amino alcohols, heterocyclic alcohols, and mixtures thereof.

In yet another aspect, the present invention is directed to a method of making a solid or concentrated liquid fertilizer composition comprising treating (e.g., contacting, spray applying, brushing, etc) one or more nitrogenous fertilizer compounds with a nitrification inhibitor composition that comprises neem or neem oil solubilized in a liquid medium that comprises an organic solvent selected from polar aprotic solvents, amine solvents, heterocyclic alcohol solvents, and mixtures thereof.

to a concentrated solid fertilizer composition comprising:
(a) solid particles of one or more nitrogenous fertilizer compounds, and
(b) a natural nitrification inhibitor and an alkyl thiophosphoric triamide supported on at least a portion of the solid particles.

In yet another aspect, the present invention is directed to a method of making an high temperature stable, aqueous end use fertilizer composition comprising contacting one or more nitrogenous fertilizer compounds with a natural nitrification inhibitor solubilized in a liquid medium that comprises an organic solvent selected from polar aprotic solvents, amine solvents, amine alcohols, heterocyclic alcohol solvents, dimethylsulfoxide, or mixtures thereof.

In a further aspect, the present invention is directed to a method for fertilizing target plants, comprising applying an aqueous end use fertilizer composition that comprises:
one or more nitrogenous fertilizer compounds;
at least one nitrification inhibitor, at least one urease inhibitor, or a combination thereof;
at least one organic solvent as described herein, which in one embodiment is selected from dimethyl sulfoxide, dimethyl formamide, the dimethyl ester of succinic acid, dimethyl ester of ethyl succinic acid, the dimethyl ester of glutaric acid, the dimethyl ester of methyl glutaric acid, and the dimethyl ester of adipic acid, diethylene triamine, or monoethanolamine, methyl-5-(dimethylamino)-2-methyl-oxopentanoate, dimethylaminoethanol, triethanol amine, a heterocyclic alcohol according to formula (II.a):

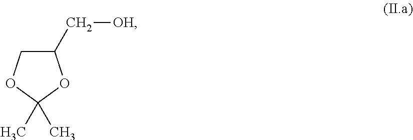

Or mixtures thereof; and
(e) optionally, water,
   to the target plants or to an environment for the target plants.

### DETAILED DESCRIPTION

As used herein, the term “alkyl” means a saturated straight chain, branched chain, or cyclic hydrocarbon radical, including but not limited to, methyl, ethyl, n-propyl, iso-propyl, n-butyl, sec-butyl, t-butyl, pentyl, n-hexyl, and cyclohexyl.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, am inophenyl, and tristyrylphenyl.

As used herein, the term “alkylene” means a divalent saturated straight or branched chain hydrocarbon radical, such as for example, methylene, dimethylene, trimethylene.

As used herein, the term “alkoxyl” means an oxy radical that is substituted with an alkyl group, such as for example, methoxyl, ethoxyl, propoxyl, isopropoxyl, or butoxyl, which may optionally be further substituted on one or more of the carbon atoms of the radical.

As used herein, the term “alkoxyalkyl” means an alkyl radical that is substituted with one or more alkoxy substituents, more typically a (C₁—C₂₂)alkyloxy-(C₁—C₆)alkyl radical, such as methoxymethyl, and ethoxybutyl.

As used herein, the term “alkenyl” means an unsaturated straight or branched hydrocarbon radical, more typically an unsaturated straight, branched, (which, in one particular embodiment, is C₁—C₇₅) hydrocarbon radical, that contains one or more carbon-carbon double bonds, such as, for example, ethenyl, n-propenyl, iso-propenyl.

As used herein, the term “arylalkyl” means an alkyl group substituted with one or more aryl groups, more typically a (C₁—C₁₈)alkyl substituted with one or more (C₆—C₁₄)aryl substituents, such as, for example, phenylmethyl, phenylethyl, and triphenylmethyl.

As used herein, the term “aryloxy” means an oxy radical substituted with an aryl group, such as for example, phenyloxy, methylphenyl oxy, isopropylmethylphenyloxy.

As used herein, the terminology “(Cᵣ—Cₛ)” in reference to an organic group, wherein r and s are each integers, indicates that the group may contain from r carbon atoms to s carbon atoms per group.

Dicyandiamide is a known compound according to formula (I.b):

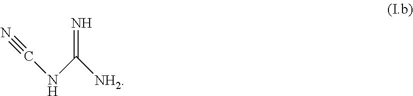

Dicyandiamide, also known as “2-cyanoguanidine”, is typically made by treating cyanamide with base and is commercially available.

In one embodiment, the compositions according to the present invention comprise a urease inhibitor, such as an alkyl thiophosphoric triamide or ammonium thiosulfate, a nitrification inhibitor, or a combination of both a urease inhibitor and a nitrification inhibitor. In another embodiment, the compositions according to the present invention comprise a urease inhibitor, such as an alkyl thiophosphoric triamide or ammonium thiosulfate, a nitrification inhibitor, or a combination of both a urease inhibitor and a nitrification inhibitor that are solubilized in a solvent system. Nitrification inhibitors, in one embodiment, includes both synthetic nitrification inhibitors and natural nitrification inhibitors.

Natural nitrification inhibitors include neem, including but not limited to neem oil, neem cake and/or neem powder; koronivia, including but not limited to koronivia grass; karanj, including but not limited to karanjin seed extract and/or karanj oil; mahua, including but not limited to mahua oil; castor, including but not limited to castor oil; mint, including but not limited to mint oil; and any combination thereof.

These natural nitrification inhibitors have benefits over synthetic nitrification inhibitors in terms of cost, availability, and adverse influence on beneficial soil microorganisms. Natural nitrification inhibitors or plant-based nitrification inhibitors, on the contrary, can be naturally sourced. Meaning, in many instances, these natural nitrification inhibitor are environmentally friendly and biodegradable. The natural nitrification inhibitors can also be cheaper to manufacture. The natural nitrification inhibitors can also have a safer toxicological profile versus synthetic nitrification inhibitors.

In one embodiment, the urease inhibitor is N-(n-Butyl) thiophosphoric triamide (NBPT), N-(n-Butyl) phosphoric triamide (NBPTO or BNPO), phenylphosphorodiamidate (PPD/PPDA), hydroquinone, ammonium thiosulfate, or any combination thereof.

In one embodiment, alkyl thiophosphoric triamide is N-(n-butyl)-thiophosphoric triamide (“NBPT”). The at least one of alkyl thiophosphoric triamide or dicyandiamide or combination thereof can be present in the liquid agricultural composition at a lower limit of 2% by weight of the composition. In another embodiment, the at least one of alkyl thiophosphoric triamide or a nitrification inhibitor (including neem/neem oil), or combination thereof, can be present in the liquid agricultural composition at a lower range of 3% by weight of the composition. The at least one of alkyl thiophosphoric triamide or neem/neem oil (or a combination thereof) can be present in the liquid agricultural composition at a lower range of 5% by weight of the composition.

In another embodiment, at least one urease inhibitor and/or nitrification inhibitor can be present, collectively, in the liquid agricultural composition at a lower limit of 0.5%, or 1%, or 2%, or 3%, or 4%, or 5%, 6%, or 8%, or 10% or 12% or 14%, by weight of the composition. The at least one nitrification inhibitor or urease inhibitor or combination thereof can be present in the liquid agricultural composition at an upper limit of 75%, or 65%, or 60% or 55% or 54% or 53%, or 51%, or 50% or 47% or 45% by weight of the composition. In another embodiment, the at least one nitrification inhibitor or urease inhibitor or combination thereof can be present in the liquid agricultural composition at an upper limit of 60% by weight of the composition. In another embodiment, the at least one nitrification inhibitor or urease inhibitor or combination thereof can be present in the liquid agricultural composition at an upper limit of 55% by weight of the composition. In another embodiment, the at least one nitrification inhibitor and/or urease inhibitor can be present in the liquid agricultural composition at an upper limit of 59%, or 57%, or 55% or 53% or 50%, by weight of the composition. In another embodiment, the at least one nitrification inhibitor and/or urease inhibitor can be present in the liquid agricultural composition at an upper limit of 48%, or 46%, or 45% or 42% or 40%, by weight of the composition.

In some embodiments, the dibasic ester or blend of dibasic esters comprises adducts of alcohol and linear diacids, the adducts having the formula (IV):

R—OOC-A-COO—R (IV)

wherein R is an alkyl group (e.g., methyl, ethyl, etc.) and A is a mixture of —(CH2)4-, —(CH2)3, and —(CH2)2-. In other embodiments, the blend comprises adducts of alcohol, typically ethanol, and linear diacids, the adducts having the formula R1—OOC-A-COO—R2, wherein at least part of R1 and/or R2 are residues of at least one linear alcohol having 4 carbon atoms, and/or at least one linear or branched alcohol having at least 5 carbon atoms, and wherein A is a divalent linear hydrocarbon. In some embodiments A is one or a mixture of —(CH2)4-, —(CH2)3, and —(CH2)2-. In other embodiments, the dibasic ester comprises adducts of an alcohol and linear or branched diacids, the adducts having the formula (IV): R—OOC-A-COO—R, wherein R is an alkyl group (e.g., methyl, ethyl, etc.) and A one of the following: —(CH2)4-, —(CH2)3, —(CH2)2-, —CH2-, or any mixture thereof.

Dibasic esters of the present invention may be derived from one or more by-products in the production of polyamide, for example, polyamide 6,6. In one embodiment, the at least one dibasic ester comprises a blend of linear or branched, cyclic or noncyclic, C1—C20 alkyl, aryl, alkylaryl or arylalkyl esters of adipic diacids, glutaric diacids, and succinic diacids. In another embodiment, the composition comprises a blend of linear or branched, cyclic or noncyclic, C1—C20 alkyl, aryl, alkylaryl or arylalkyl esters of adipic diacids, methylglutaric diacids, and ethylsuccinic diacids

Generally, polyamide is a copolymer prepared by a condensation reaction formed by reacting a diamine and a dicarboxylic acid. Specifically, polyamide 6,6 is a copolymer prepared by a condensation reaction formed by reacting a diamine, typically hexamethylenediamine, with a dicarboxylic acid, typically adipic acid.

In one embodiment, the blend of dibasic esters can be derived from one or more by-products in the reaction, synthesis and/or production of adipic acid utilized in the production of polyamide, the composition comprising a blend of dialkyl esters of adipic diacids, glutaric diacids, and succinic diacids (herein referred to sometimes as “AGS” or the “AGS blend”).

In one embodiment, the blend of esters is derived from by-products in the reaction, synthesis and/or production of hexamethylenediamine utilized in the production of polyamide, typically polyamide 6,6. The composition comprises a blend of dialkyl esters of adipic diacids, methylglutaric diacids, and ethylsuccinic diacids (herein referred to sometimes as “MGA”, “MGN”, “MGN blend” or “MGA blend”).

In certain embodiments, the dibasic ester blend comprises:

a diester of formula (IV.a):

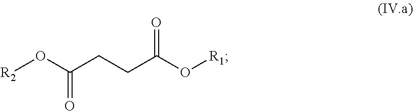

a diester of formula (IV.b):

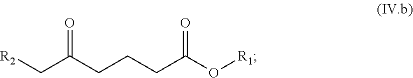

and

a diester of formula (IV.c):

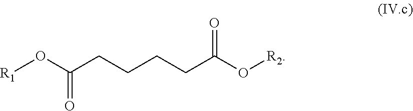

R1 and/or R2 can individually comprise a hydrocarbon having from about 1 to about 8 carbon atoms, typically, methyl, ethyl, propyl, isopropyl, butyl, isobutyl, n-butyl, isoamyl, hexyl, heptyl or octyl. In such embodiments, the blend typically comprises (by weight of the blend) (i) about 15% to about 35% of the diester of formula (IV.a), (ii) about 55% to about 70% of the diester of formula (IV.b), and (iii) about 7% to about 20% of the diester of formula (IV.c), and more typically, (i) about 20% to about 28% of the diester of formula (IV.a), (ii) about 59% to about 67% of the diester of formula (IV.b), and (iii) about 9% to about 17% of the diester of formula (IV.c). The blend is generally characterized by a flash point of 98° C., a vapor pressure at 20° C. of less than about 10 Pa, and a distillation temperature range of about 200-300° C.

In certain other embodiments, the dibasic ester blend comprises:

a diester of the formula (IV.d):

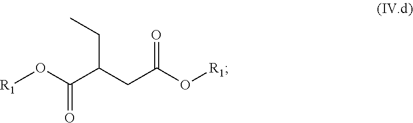

a diester of the formula (IV.e):

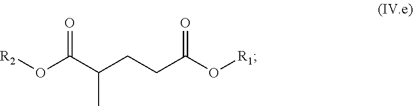

and, optionally,

a diester of the formula (IV.c):

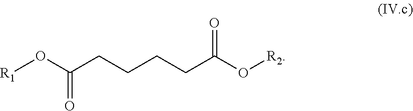

R1 and/or R2 can individually comprise a hydrocarbon having from about 1 to about 8 carbon atoms, typically, methyl, ethyl, propyl, isopropyl, butyl, isobutyl, n-butyl, isoamyl, hexyl, heptyl, or octyl. In such embodiments, the blend typically comprises (by weight of the blend) (i) from about 5% to about 30% of the diester of formula (IV.d), (ii) from about 70% to about 95% of the diester of formula (IV.e), and (iii) from about 0% to about 10% of the diester of formula (IV.c). More typically, the blend typically comprises (by weight of the blend): (i) from about 6% to about 12% of the diester of formula (IV.d), (ii) from about 86% to about 92% of the diester of formula (IV.e), and (iii) from about 0.5% to about 4% of the diester of formula (IV.c).

Most typically, the blend comprises (by weight of the blend): (i) about 9% of the diester of formula (IV.d), (ii) about 89% of the diester of formula (IV.e), and (iii) about 1% of the diester of formula (IV.c). The blend is generally characterized by a flash point of of 98° C., a vapor pressure at 20° C. of less than about 10 Pa, and a distillation temperature range of about 200-275° C.

In another embodiment, the at least one nitrification inhibitor and/or urease inhibitor can be present in the liquid agricultural composition in an amount between about 7% by weight of the composition to about 55% by weight of the composition. In another embodiment, the at least one nitrification inhibitor and/or urease inhibitor can be present in the composition in an amount between about 8% by weight of the composition to about 50% by weight of the composition. In another embodiment, the at least one nitrification inhibitor and/or urease inhibitor can be present in the liquid agricultural composition in an amount between about 7% by weight of the composition to about 45% by weight of the composition. In another embodiment, the at least one nitrification inhibitor and/or urease inhibitor can be present in the liquid agricultural composition in an amount between about 7% by weight of the composition to about 40% by weight of the composition.

The at least one nitrification inhibitor and/or urease inhibitor means that the urease inhibitor (e.g., alkyl thiophosphoric triamide) is solely present, the nitrification inhibitor (e.g., neem oil) is solely present, or a combination is present.

Certain compounds are suitable as a stabilizer (which can be a co-solvent or additive) component of the composition and methods of the present invention are alkanolamines. In one embodiment, the stabilizer is a monoalkanolamine. In another embodiment, the stabilizer is a dialkanolamine. In another embodiment, the stabilizer is a trialkanolamine. In yet another embodiment, the stabilizer is monoethanolamine. In a further embodiment, the stabilizer is diethanolamine. In yet a further embodiment, the stabilizer is a triethanolamine. In another embodiment, the alkanol group is chosen from methanol, ethanol, propanol, butanol. The stabilizer component forms stable compositions at room temperature, high temperatures or low temperatures, with the nitrification and/or urease inhibitor, which in some embodiments means stability at temperatures ranging from −16° C. to 54° C., in other embodiments, −10° C. to 40° C., in other embodiments, −5° C. to 40° C., in other embodiments, −2° C. to 40° C., or in other embodiments, 0° C. to 40° C.

In some embodiments, certain solvents in combination with one or more nitrification inhibitors and/or urease inhibitors degrade over time. This drawback is seen, for example, in sulfur containing solvents such as dimethylsulfoxide and sulfones. For example, in one embodiment, the sulfur-containing solvents degrade, which negatively affects properties of the liquid composition such as flash point. However it has been surprisingly discovered that a combination of a sulfur containing solvent in addition to a co-solvent or stabilizer delays or retards such degradation. The co-solvent or stabilizer, in one embodiment, is an amine alcohol including but not limited to methanolamine or an aminoalkoxy alcohol.

In another embodiment, compounds suitable as the organic solvent are polar aprotic solvents, heterocyclic alcohol solvents, and/or mixtures thereof, that form liquid, or otherwise stable, compositions with the nitrification and/or urease inhibitor at temperatures at or greater than −16° C., in alternative embodiments, greater than −14° C., in other embodiments, greater than −12° C., in other embodiments, greater than −10° C., in further embodiments, greater than −8° C., in other embodiments, greater than −5° C., in other embodiments, greater than −3° C., in other embodiments, greater than −2° C., in other embodiments, greater than 0° C., in other embodiments, greater than 2° C., in other embodiments, greater than 4° C., in other embodiments, greater than 5° C.

In some embodiments, at high temperature ranges or at greater than a specified temperature (as described herein), the liquid fertilizer composition is stable, meaning the urease and/or nitrification inhibitor(s) do not react with the solvent or solvent component under anticipated manufacturing, storage, and use conditions. In one embodiment, the liquid fertilizer compositions are stable at a temperature greater than 25° C. In one embodiment, the liquid fertilizer compositions are stable at a temperature greater than 27° C. In one embodiment, the liquid fertilizer compositions are stable at a temperature greater than 29° C. In one embodiment, the liquid fertilizer compositions are stable at a temperature greater than 30° C. In one embodiment, the liquid fertilizer compositions are stable at a temperature greater than 32° C. In one embodiment, the liquid fertilizer compositions are stable at a temperature greater than 34° C. In one embodiment, the liquid fertilizer compositions are stable at a temperature greater than 35° C. In one embodiment, the liquid fertilizer compositions are stable at a temperature greater than 37° C. In one embodiment, the liquid fertilizer compositions are stable at a temperature greater than 40° C. In one embodiment, the liquid fertilizer compositions are stable at a temperature greater than 42° C. In one embodiment, the liquid fertilizer compositions are stable at a temperature greater than 44° C. In one embodiment, the liquid fertilizer compositions are stable at a temperature greater than 45° C. In one embodiment, the liquid fertilizer compositions are stable at a temperature greater than 47° C. In one embodiment, the liquid fertilizer compositions are stable at a temperature greater than 50° C.

In one embodiment, at the specified temperature ranges or at greater than a specified temperature (as described herein), the liquid fertilizer composition is stable, meaning the liquid fertilizer composition is or substantially is in one phase, i.e., no visible crystals, no visible precipitation, and/or no visible multiple liquid phases. In another embodiment, the liquid fertilizer composition is stable, meaning the liquid fertilizer composition is or substantially is in one phase and shows little or slight discoloration.

Suitable polar aprotic organic solvents include, for example, dichloromethane, dimethyl acetamide, dimethyl formamide, dimethyl sulfoxide, ethyl acetate, hexamethylphosphoramide, dimethyl sulfone, sulfolane, 1,3-dimethyl-2-imidazoidinone, 1,3-dimethyl-3,4,5,6-tetrahydro-2(1H)-pyrimidone, methyl acetate, ethyl lactate, methylpyrrolidone, tetrahydrofuran, propylene carbonate, and dibasic ester solvents.

In one embodiment, suitable solvents include at least one solvent from the following:

(a) at least one dioxolane compound of formula (I.b):

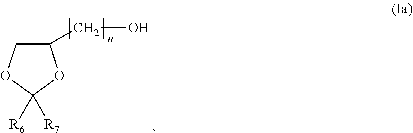

wherein R₆ and R₇ individually comprises a hydrogen, an alkyl group, an alkenyl group, or a phenyl group, wherein n is an integer of from 1 to 10; b) at least one dibasic ester; c) at least one compound of formula (III):

R₃OOC-A-CONR₄R₅ (III)

wherein R₃ comprises a C₁—C₃₆ alkyl group; wherein R₄ and R₅ individually comprise a C₁—C₃₆ alkyl group, wherein R₄ and R₅ can optionally together form a ring; and wherein A is a linear or a branched divalent C₂—C₆ alkyl group; d) at least one alkyldimethylamide; e) at least one alkyl lactate; f) ethyl levulinate; g) at least one alkyoxyalcohol, ether alcohol, amine alcohol, amino alcohol or alcohol; h) at least one glycol, glycol derivative, glycerine or glycerine derivative; i) at least one alkylene carbonate; j) dimethylsulfoxide; k) an amine selected from monoalkanolamine, dialkanolamine, trialkanolamine, monoethanolamine, diethanolamine and triethanolamine; l) a sulfone or sulfolane; m) an aminoalkoxy alcohol; n) cyclohexanone or cyclopentanone; o) benzyl alcohol; or p) any combination thereof, wherein the at least one nitrification inhibitor is dispersed or solubilized in the at least one solvent

Glycols and glycol derivatives include but are not limited to aliphatic dihydroxy (dihydric) alcohols. In one embodiment, glycol derivatives include but are not limited to polypropylene glycol, triethylene glycol, glycol alkyl ethers such as dipropylene glycol methyl ether, diethylene glycol. In another embodiment, glycol derivatives include but are not limited to polyglycols such as polyethylene glycols (PEG) and polypropylene glycols. Glycols are represented by the general formula Cn H2n (OH)2, where n is at least 2. Non-limiting examples of glycols include ethylene glycol (glycol), propylene glycol (1,2-propanediol), 1,4-butanediol, 1,5-pentanediol, 1,6-hexanediol, 1,7-heptanediol, 1,9-nonanediol, 1,10-decanediol, 1,8-octanediol, 1,3-propanediol, 1,3-butanediol, 1,4-butanediol, 2,3-butanediol, 2,4-pentanediol, 2,5-hexanediol, 4,5-octanediol and 3,4-hexanediol, neopentylglycol, pinacol, 2,2-diethyl-1,3-propanediol, 2-ethyl-1,3-hexanediol, 2-ethyl-2-butyl-1,3-propanediol, isobutylene glycol, 2,3-dimethyl-1,3-propanediol, 1,3-diphenyl-1,3-propanediol, 3-methyl-1,3-butanediol.

In another embodiment, glycol derivatives include but are not limited to glycol stearate, ethylene glycol monostearate, ethylene glycol distearate, ethylene glycol amido stearate, dilaurate glycol, propylene glycol monostearate, propylene glycol dicaprylate, propylene glycol dicaprate diacetate glycol, dipalmite glycol, diformate glycol, dibutyrate glycol, dibenzorate glycol, dipalmate glycol, dipropionate glycol, monoacetate glycol, monopalmitate glycol and monoformate glycol.

Polyglycol derivatives include but are not limited to polyethylene glycol (PEG) 200-6000 mono and dilaurates, such as, PEG 600 dilaurate, PEG 600 monolaurate, PEG 1000 dilaurate, PEG 1000 monolaurate, PEG 1540 dilaurate and PEG 1540 monolaurate, polyethylene glycol 200-6000 mono and dioleates, such as, PEG 400 monoleate, PEG 600 dioleate, PEG 600 monooleate, PEG 1000 monoleate, PEG 1540 dioleate, PEG 1540 monooleate and polyethylene glycol 200-6000 mono and distearates, such as, PEG 400 distearate, PEG 400 monostearate, PEG 600 distearate, PEG 600 monostearate, PEG 1000 distearate, PEG 1000 monostearate, PEG 1540 distearate, PEG 1540 monostearate and PEG 3000 monostearate.

Examples of glycerol derivatives include but are not limited to glycerol monolaurate, glycerol monostearate, glycerol distearate, glycerol trioleate, glycerol monooleate, glycerol dilaurate, glycerol dipalmitate, glycerol triacetate, glycerol tribenzoate, glycerol tributyrate, glycerol monopalmitate, glycerol trimyristate, glycerol trilaurate, glycerol tripalmitate and glycerol tristearate.

Suitable dibasic ester solvents include, for example, dialkyl esters of dicarboxylic acids, more typically, the di(C₁—C₁₂)alkyl esters of saturated linear or branched (C₂—C₈)aliphatic carboxylic acids or a mixture thereof. In one embodiment, the dibasic ester component comprises one or more compounds according to formula (III):

R¹OOC-A-CONR²R³ (III)

wherein:
A is a divalent linear or branched (C₂—C₈)aliphatic group, and
R¹, R², and R³ are each independently (C₁—C₁₂)alkyl, (C₁—C₁₂)aryl, (C₁—C₁₂)alkaryl or (C₁—C₁₂)arylalkyl, and R² and R³ may each optionally be substituted with one or more hydroxyl groups.

In one embodiment, the dibasic ester solvent component of the compositions and methods of the present invention comprises one or more dimethyl esters of saturated linear or branched (C₄—C₆)aliphatic carboxylic acids, such the dimethyl ester of succinic acid, dimethyl ester of ethyl succinic acid, the dimethyl ester of glutaric acid, the dimethyl ester of methyl glutaric acid, and the dimethyl ester of adipic acid, and mixtures thereof. In one embodiment, the dibasic ester component comprises the dimethyl ester of succinic acid, the dimethyl ester of glutaric acid, and optionally, the dimethyl ester of adipic acid, In another embodiment, the dibasic ester component comprises the dimethyl ester of ethyl succinic acid, the dimethyl ester of methyl glutaric acid, and optionally, the dimethyl ester of adipic acid.

In one embodiment, the dibasic ester solvent component of the compositions and methods of the present invention comprises one or more dialkyl esters of saturated linear or branched (C₄—C₆)aliphatic carboxylic acids, such the dialkyl ester of succinic acid, dialkyl ester of ethylsuccinic acid, the dialkyl ester of glutaric acid, the dialkyl ester of methylglutaric acid, and the dialkyl ester of adipic acid, and mixtures thereof. In one embodiment, the dibasic ester component comprises the dialkyl ester of succinic acid, the dialkyl ester of glutaric acid, and optionally, the dimethyl ester of adipic acid, In another embodiment, the dibasic ester component comprises the dialkyl dimethyl ester of ethylsuccinic acid, the dialkyl ester of methylglutaric acid, and optionally, the dialkyl ester of adipic acid. Each alkyl group in the dialkyl group, one embodiment, individually comprise a C₁—C₈ alkyl. In another embodiment, each alkyl group in the dialkyl group, one embodiment, individually comprise a C₁—C₄ alkyl. In another embodiment, each alkyl group in the dialkyl group, one embodiment, individually comprise a C₁—C₆ alkyl.

Suitable amine solvents include primary amines, including monoalkylamines, such as propylamine, secondary amines, including dialkyl amines and diaryl amines, such as dimethylamine and diphenylamine, and tertiary amines, such as diethylene triamine and methyl-5-(dimethylamino)-2-methyl-oxopentanoate. Suitable aminoalkoxy alcohols comprise 2-(2-aminoalkoxy)ethanol or 2-(2-aminoethoxy)ethanol. In one embodiment, the amine solvent component of the compositions and methods of the present invention is selected from aliphatic or aromatic primary, secondary, or tertiary amines may optionally further comprise one or more additional functional groups, such as hydroxyalkyl groups, hydroxyl groups, carbonyl groups, or alkyl ester groups, other than one or more amino groups.

In one embodiment, the organic solvent component of the compositions and methods of the present invention comprises an amino alcohol. Compounds suitable as the amino alcohol solvent component of the compositions and methods of the present invention are those compounds that comprise at least one primary, secondary, or tertiary amino moiety per molecule and at least one hydroxyalkyl moiety per molecule, more typically In one embodiment, the amino alcohol is a linear, branched, or cyclic, saturated or unsaturated hydrocarbon that is substituted on at least one carbon atom with an amino group and on at least one other carbon atom with hydroxyalkyl or hydroxyl group, such as monoethanolamine, ethylaminoethanol, dimethylaminoethanol, isopropylaminoethanol, diethanolamine, triethanolamine, methylaminoethanol, aminopropanol, methylaminopropanol, dimethylaminopropanol, am inobutanol, dimethylaminobutanol, am inobutanediol, trihydroxymethylaminoethane, diethylaminopropanediol, 1-amino-cyclopentane methanol, and aminobenzyl alcohol, or a heterocyclic ring that comprises at least one nitrogen atom as a ring member and/or is substituted on at least one carbon atom with an amino group and that is substituted on at least one other carbon atom with a hydroxyalkyl or hydroxyl group, such as methylaminomethyl-1,3-dioxolane. In one embodiment, the amino alcohol includes Am ino-2-propanol and 2-Amino-2-Methyl-1-Propanol.

Suitable heterocyclic alcohol solvents include, for example, 5- or 6-membered heterocyclic rings that include 1 or 2 oxygen atoms as ring member, that are substituted on at least one carbon atom of the ring with a (C₁—C₆)hydroxyalkyl group, and that may optionally be substituted on one or more carbon atoms of the ring with one or more (C₁—C₄)alkyl groups. It is understood that the term heterocyclic alcohol includes dioxolane compounds. In one embodiment, the heterocyclic alcohol component of the present invention comprises a one or more compounds selected from heterocyclic alcohols according to formulas (II.c), (II.d), (II.e), (II.f), and (II.g):

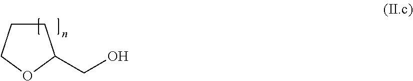

wherein n=1 or 2,

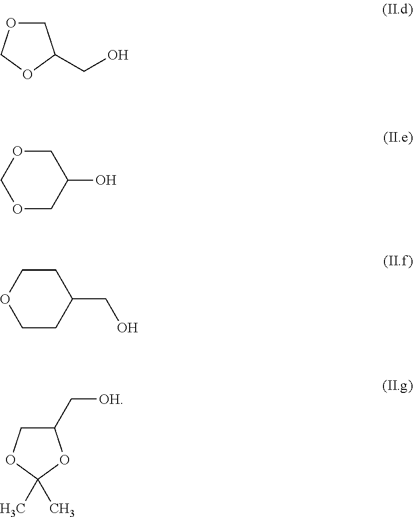

In one embodiment, the organic solvent component comprises one or more dibasic ester compounds according to any of formula (III) or formula (IV), one or more amino alcohols, one or more tertiary amines, one or more heterocyclic alcohols according to formulas (II.a-II.g), or mixtures thereof.

In one embodiment, suitable solvents include any one or more of the following: an alkoxypropyl amine including but not limited to 3-methoxypropyl amine, 3-Dimethylamino-1-propanol, 4-Hydroxy-4-methyl-2-pentanone, a dialkylacetamine such as N,N-Dimethylacetamide, Amino-2-propanol, Cyclohexanone, 2-butoxyethanol, N-Methylpyrrolidine, Cyclopentanone, 2-Hydroxyethyl acrylate, Tetradecane, 2-Hydroxyethyl acrylate, acetonitrile, a glycol or glycol derivative including but not limited to Polypropylene glycol, Triethylene Glycol, Dipropylene Glycol Methyl Ether, Diethylene Glycol, Morpholine, alkanolamines including but not limited to methanolamine, γ-Butyrolactone, Furfuryl alcohol, Tri-n-Butyl Phosphate, acetophenone, 4-acetalmorpholine, formamide, or 1-ethyl-2-pyrrolidone, or any combination thereof. In another embodiment, the at least one solvent is a sulfone, including but not limited to sulfolane.

In one embodiment, the organic solvent component of the composition and methods of the present invention comprises dimethyl sulfoxide, dimethyl formamide, the dimethyl ester of succinic acid, dimethyl ester of ethyl succinic acid, the dimethyl ester of glutaric acid, the dimethyl ester of methyl glutaric acid, and the dimethyl ester of adipic acid, diethylene triamine, or monoethanolamine, methyl-5-(dimethylamino)-2-methyl-oxopentanoate, dimethylaminoethanol, triethanol amine, a heterocyclic alcohol according to any of formulas (II.a-II.g), or a mixture thereof.

In one embodiment, the organic solvent component of the composition and methods of the present invention comprises dimethyl sulfoxide, dimethyl formamide, diethylene triamine, monoethanolamine, or a mixture thereof.

In one embodiment, the organic solvent component of the composition and methods of the present invention comprises a mixture of at least one organophosphate solvent according to formula (VIII), wherein R₁, R₂ and R₃ are as described above, and dimethyl sulfoxide.

In one embodiment, the at least one organophosphate solvent has the formula (VIII)

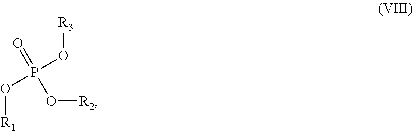

wherein R₁, R₂ and R₃, are each independently chosen from H, a C₁—C₁₆ alkyl group, a C₁—C₁₆ alkenyl, group, a C₁—C₁₆ alkoxyalkyl group, a C₇—C₃₀ alkylarylalkyl group, a C₇—C₃₀ arylalkyl group, or an aryl group; provided that at least one of R₁, R₂ or R₃ is not H. In another embodiment, R₁, R₂ and R₃, are each independently chosen from H, a C₁—C₁₂ alkyl group, a C₁—C₁₂ alkenyl, group, a C₁—C₁₂ alkoxyalkyl group, a C₇—C₃₀ alkylarylalkyl group, a C₇—C₃₀ arylalkyl group, or an aryl group; provided that at least one of R₁, R₂ or R₃ is not H. In one embodiment, R₁, R₂ and R₃, are each independently chosen from H, a C₁—C₄ alkyl group, a C₄—C₈ alkyl group, a C₁—C₁₂ alkenyl, group, a C₁—C₄ alkoxyalkyl group, a C₇—C₃₀ alkylarylalkyl group, a C₇—C₃₀ arylalkyl group, or an aryl group; provided that at least one of R₁, R₂ or R₃ is not H.

In yet another embodiment, R₁, R₂ and R₃, are each independently chosen from a C₁—C₁₂ alkyl group, a C₁—C₁₂ alkenyl, group, a C₁—C₁₂ alkoxyalkyl group, a C₇—C₃₀ alkylarylalkyl group, a C₇—C₃₀ arylalkyl group, or an aryl group. In one embodiment, R₁, R₂ and R₃, are each independently chosen from a C₁—C₁₂ alkyl group, more typically, a C₂—C₈ alkyl group.

In one embodiment, a compound utilized as the solvent or as a component in the solvent blend is a compound of general formula (III):

R₃OOC-A-CONR₄R₅ (III),

According to one embodiment, the expression “compound” denotes any compound corresponding to the general formula (III). In other embodiments, the term “compound” also refers to mixtures of several molecules corresponding to general formula (III). It may therefore be a molecule of formula (III) or a mixture of several molecules of formula (III), wherein both fall under the definition of the term “compound” when referring to formula (III).

The R₃, R₄ and R₅ groups can be, in some embodiments, identical or, in other embodiment, different. In one embodiment, may be groups chosen from C₁—C₂₀ alkyl, aryl, alkaryl or arylalkyl groups or the phenyl group. In another embodiment, may be groups chosen from C₁—C₁₂ alkyl, aryl, alkaryl or arylalkyl groups or the phenyl group. Mention is made especially of Rhodiasolv® PolarClean (Manufactured by Solvay USA Inc., Cranbury, N.J.). The R₄ and R₅ groups may optionally be substituted. In one particular embodiment, the groups are substituted with hydroxyl groups.

In one embodiment, R₃ group is chosen from methyl, ethyl, propyl, isopropyl, n-butyl, isobutyl, n-pentyl, isopentyl, isoamyl, n-hexyl, cyclohexyl, 2-ethylbutyl, n-octyl, isooctyl, 2-ethylhexyl, tridecyl groups.

R₄ and R₅ groups, which are identical or different, in one embodiment, may especially be chosen from methyl, ethyl, propyl (n-propyl), isopropyl, n-butyl, isobutyl, n-pentyl, amyl, isoamyl, hexyl, cyclohexyl or hydroxyethyl groups. The R₄ and R₅ groups may also be such that they form, together with the nitrogen atom, a morpholine, piperazine or piperidine group. According to some embodiments, R₄ and R₅ are each methyl, or R₄ and R₅ are each ethyl, or R₄ and R₅ are each hydroxyethyl.

According to one embodiment, if A comprises a linear group of formula —CH₂— CH₂— and/or of formula —CH₂— CH₂— CH₂— CH₂— and/or of formula —(CH₂)₈— then it is a mixture of A groups. According to one particular embodiment, if A is linear, then it is a mixture of A groups, for example a mixture of two or three —CH₂— CH₂— (ethylene);—CH₂— CH₂— CH₂— (n-propylene); and —CH₂— CH₂— CH₂— CH₂— (n-butylene) groups (or isomers thereof).

According to a first particular embodiment of the invention, the A group is a divalent linear alkyl group chosen from the groups of the following formulae: —CH₂— CH₂— (ethylene); —CH₂— CH₂— CH₂— (n-propylene); —CH₂— CH₂— CH₂— CH₂— (n-butylene), and mixtures thereof.

In one embodiment, the inhibitor composition of the present invention comprises, based on 100 parts by weight (“pbw”) of the composition:

from about 4 to about 60 pbw, more typically from about 10 to about 55 pbw, and even more typically from about 20 to about 40 pbw nitrification inhibitor (which in one embodiment is neem oil), and

from about 55 to about 96 pbw, more typically from about 58 to about 90 pbw, and even more typically from about 60 to about 80 pbw of the organic solvent.

In one embodiment, the inhibitor composition of the present invention comprises one or more urease inhibitors, such as, for example, NBPT or ammonium thiosulfate.

The nitrogenous fertilizer compound is treated with the inhibitor composition by contacting the nitrogenous fertilizer composition with the inhibitor composition described herein (e.g., nitrification inhibitor or urease inhibitor or a combination of both). The nitrogenous fertilizer composition may be in solid or liquid form.

Suitable nitrogenous fertilizers are those containing a nitrogenous compound such as urea, nitrate salts, ammonium salt, or a mixture thereof, such as ammonium nitrate, ammonium sulfate, ammonium thiosulfate, ammonium polysulfide, ammonium phosphates, ammonium chloride, ammonium bicarbonate, anhydrous ammonia, calcium nitrate, nitrate soda, calcium cyanamide. In one embodiment, the nitrogenous fertilizer comprises ammonium nitrate. Suitable ammonium nitrate-containing fertilizers include, for example, UAN 18, UAN 28, and UAN 30.

In one embodiment, the nitrogenous fertilizer composition is in solid particulate form, and the contacting of the nitrogenous fertilizer composition with the inhibitor composition is conducted by, for example, spraying the composition of the present invention on the particles of solid fertilizer composition.

In one embodiment, the concentrated fertilizer composition of the present invention is a solid nitrification-inhibited fertilizer composition that comprises, based on 100 pbw of the composition:

from about 60 pbw to about 99.999, more typically from about 70 pbw to about 99.999, and even more typically from about 80 pbw to about 99.999 solid particles of one or more nitrogenous fertilizer compounds, and

from about 0.001 to about 40 pbw, more typically from about 0.001 to about 30 pbw, and even more typically from about 0.001 to about 20 pbw, nitrification inhibitor.

In one embodiment, the solid nitrification-inhibited fertilizer composition of the present invention further comprises one or more urease inhibitors, more typically NBPT.

In one embodiment, the end use fertilizer composition of the present invention is made by combining the inhibitor composition of the present invention with a solid nitrogenous fertilizer to form a solid nitrification-inhibited fertilizer composition and subsequently dissolving the solid nitrification-inhibited fertilizer composition in an aqueous medium, typically water, in a ratio of up to about 500 pbw, more typically from 100 to 500 pbw and even more typically from about 100 to about 300 pbw, of the aqueous medium per 1 pbw of the solid nitrification-inhibited fertilizer composition.

In one embodiment, the fertilizer compound is in liquid form and the contacting of the fertilizer composition with the inhibitor composition is conducted by mixing the inhibitor composition with the liquid fertilizer composition.

In one embodiment, the concentrated fertilizer composition of the present invention is a concentrated liquid nitrification-inhibited fertilizer composition that comprises, based on 100 pbw of the composition:

from about 20 to about 99.989 pbw, more typically from about 30 to about 99.985 pbw, and even more typically from about 40 to about 99.98 pbw of one or more nitrogenous fertilizer compounds,

from about 0.001 to 40 pbw, more typically from about 0.005 to 30 pbw, and even more typically from about 0.01 to 20 pbw NBPT (or NBPT in combination with a natural nitrification inhibitor), and

from about 0.01 to 60 pbw, more typically from about 0.01 to about 40 pbw, and even more typically from about 0.01 to about 30 pbw of the organic solvent or solvent mixture, as described herein.

In one embodiment, the concentrated liquid nitrification-inhibited fertilizer composition of the present invention further comprises one or more urease inhibitors, more typically NBPT.

In one embodiment, the end use fertilizer composition of the present invention is made by combining the inhibitor composition of the present invention with a concentrated nitrogenous fertilizer to form a concentrated liquid nitrification-inhibited fertilizer composition and subsequently diluting the concentrated liquid nitrification-inhibited fertilizer composition with an aqueous medium, typically water in a ratio of up to about 500 pbw, more typically from about 10 to about 500 pbw and even more typically from about 100 to about 300 pbw, of the aqueous medium per 1 pbw concentrated liquid nitrogenous fertilizer composition.

In one embodiment, the end use fertilizer composition of the present invention is made by combining the inhibitor composition of the present invention, a solid or concentrated liquid nitrogenous fertilizer, and an aqueous medium.

In one embodiment, the end use fertilizer composition of the present invention is an aqueous liquid composition that comprises water, one or more nitrogenous fertilizer compounds, and natural nitrification inhibitor, typically in an amount of from 2×10⁻⁶ pbw to about 4 pbw neem oil per 100 pbw of the end use fertilizer composition.

In one embodiment, the end use fertilizer composition of the present invention comprises water and based on 100 parts by weight of the composition:

from about 0.04 to about 10 pbw, more typically from about 0.06 to about 10 pbw, and even more typically from about 0.08 pbw to about 10 pbw to of one or more nitrogenous fertilizer compounds,

from about 2×10⁻⁶ to about 4 pbw, more typically from about 1×10⁻⁵ to about 3 pbw, and even more typically from about 2×10⁻⁴ to about 2 pbw dicyandiamide, and

from about 2×10⁻⁴ to about 6 pbw, more typically from about 2×10⁻⁴ to about 4 pbw, and even more typically from about 2×10⁻⁴ to about 3 pbw of the organic solvent.

In one embodiment, the end use fertilizer composition of the present invention comprises one or more urease inhibitors, more typically NBPT, alone or in combination with the nitrification inhibitor.

In one embodiment, the end use fertilizer composition of the present invention comprises from about 0.001 to about 5 pbw, more typically from about 0.01 to about 2 pbw dicyandiamide per 100 pbw of the one or more nitrogenous fertilizer compounds.

In one embodiment, the end use fertilizer composition is applied to target plants or to an environment for the target plants, i.e., to ground on or within which the target plants are growing or to be grown, at a rate of from about 0.01 pounds to about 5 pounds of the fertilizer composition, more typically from about 0.05 pounds to about 2 pounds of the fertilizer composition, per 100 square feet of ground.

In one embodiment, the end use fertilizer composition is applied to target plants or to an environment for the target plants at a rate effective to provide a dosage of nitrogenous fertilizer compound of from about 0.01 pounds to about 5 pounds of fertilizer compound, more typically from about 0.05 pounds to 2 pounds of fertilizer compound, per 100 square feet of ground.

In one embodiment, the end use fertilizer composition is applied to target plants or to an environment for the target plants at a rate effective to provide a dosage of dicyandiamide of from about 0.01 pounds to 5 pounds of dicyandiamide, more typically from about 0.05 pounds to 2 pounds of dicyandiamide, per 1000 square feet of ground.

In one embodiment, target plants include but are not limited to cereals, fruits, legumes, vegetables, and/or nuts. In one embodiment, target plants include but are not limited to alfalfa, rye, sorghum, millet, proso millet, foxtail millet, finger millet, sunflower, safflower, wheat, soybean, tobacco, potato, peanuts, cotton, sweet potato, cassava, coffee, coconut, pineapple, citrus trees, cocoa, tea, banana, avocado, fig, guava, mango, olive, papaya, cashew, macadamia, almond, sugar beets, sugarcane, oat, barley, vegetable, ornamental, woody plants, squash, pumpkin, hemp, zucchini, apple, pear, quince, melon, plum, cherry, peach, nectarine, apricot, strawberry, grape, raspberry, blackberry, soybean, sorghum, sugarcane, rapeseed, clover, carrot, tomatoes, lettuce, green beans, lima beans, peas, cauliflower, broccoli, turnip, radish, spinach, asparagus, onion, garlic, pepper, celery, cucumber, cantaloupe, melon, musk melon, hydrangea, hibiscus, petunias, roses, azalea, tulips, daffodils, carnation, poinsettia, chrysanthemum, loblolly pine, slash pine, ponderosa pine, lodgepole pine, monterey pine, Douglas-fir, Western hemlock, Sitka spruce, redwood, silver fir, balsam fir, western red cedar, Alaska yellow-cedar, beans, peas, guar, locust bean, fenugreek, soybean, garden beans, cowpea, mungbean, lima bean, fava bean, lentils, chickpea, pea, moth bean, broad bean, kidney bean, lentil, dry bean, Arachis, peanuts, Vicia, crown vetch, hairy vetch, adzuki bean, mung bean, chickpea, Lupinus, Pisum, Melilotus, Medicago, Lotus, lens, false indigo, turf grass, orchard grass, tall fescue, perennial ryegrass, creeping bent grass, lucerne, birdsfoot trefoil, stylosanthes species, lotononis bainessii, sainfoin or any combination thereof.

The composition of the present invention provides improved ease of handling of natural nitrification inhibitors, improved solubility characteristics, low toxicity of the organic solvents; good storage characteristics, and excellent miscibility with aqueous compositions, such as aqueous nitrogenous fertilizer formulations.

In one embodiment the composition comprises, by weight of composition, greater than 50 wt % of neem/neem oil and/or NBPT, the remainder being solvent or a mixture of solvents with the stabilizer. By way of example, in one embodiment, the fertilizer composition comprises, by weight of composition, 50 wt % of neem/neem oil and 50 wt % of a solvent blend of DMSO and at least one stabilizer as described above.

In one embodiment the composition comprises, by weight of composition, greater than 50 wt % of NBPT, the remainder being solvent or a mixture of solvents with the stabilizer. In one embodiment the composition comprises, by weight of composition, greater than 51 wt %, 52 wt %, 53 wt %, 54 wt % of NBPT, the remainder being solvent or a mixture of solvents with the stabilizer. In one embodiment the composition comprises, by weight of composition, greater than 55 wt %, 56 wt %, 57 wt %, 58 wt %, 59 wt % of NBPT, the remainder being solvent or a mixture of solvents with the stabilizer. In one embodiment the composition comprises, by weight of composition, greater than 60 wt % of NBPT, the remainder being solvent or a mixture of solvents with the stabilizer. In one embodiment the composition comprises, by weight of composition, greater than 65 wt % of NBPT, the remainder being solvent or a mixture of solvents with the stabilizer. In one embodiment the composition comprises, by weight of composition, greater than 70 wt % of NBPT, the remainder being solvent or a mixture of solvents with the stabilizer. . In one embodiment the composition comprises, by weight of composition, greater than 75wt % of NBPT, the remainder being solvent or a mixture of solvents with the stabilizer.

In one embodiment the composition comprises, by weight of composition, greater than 50 wt % of NBPT in combination with neem/neem oil, the remainder being solvent or a mixture of solvents with the stabilizer. In one embodiment the composition comprises, by weight of composition, greater than 51 wt %, 52 wt %, 53 wt %, 54 wt % of NBPT in combination with neem/neem oil, the remainder being solvent or a mixture of solvents with the stabilizer. In one embodiment the composition comprises, by weight of composition, greater than 55 wt %, 56 wt %, 57 wt %, 58 wt %, 59 wt % of NBPT in combination with neem/neem oil, the remainder being solvent or a mixture of solvents with the stabilizer. In one embodiment the composition comprises, by weight of composition, greater than 60 wt % of NBPT in combination with neem/neem oil, the remainder being solvent or a mixture of solvents with the stabilizer. In one embodiment the composition comprises, by weight of composition, greater than 65 wt % of NBPT in combination with neem/neem oil, the remainder being solvent or a mixture of solvents with the stabilizer. In one embodiment the composition comprises, by weight of composition, greater than 70 wt % of NBPT in combination with neem/neem oil, the remainder being solvent or a mixture of solvents with the stabilizer. In one embodiment the composition comprises, by weight of composition, greater than 75wt % of NBPT in combination with neem/neem oil, the remainder being solvent or a mixture of solvents with the stabilizer.

In one embodiment the composition comprises, by weight of composition, greater than 30 wt % of neem/neem oil and/or NBPT, the remainder being solvent or a mixture of solvents with the stabilizer. By way of example, in one embodiment, the fertilizer composition comprises, by weight of composition, 30 wt % of neem/neem oil and 70 wt % of a solvent blend of: (i) at least one dioxolane compound of formula (II.b):

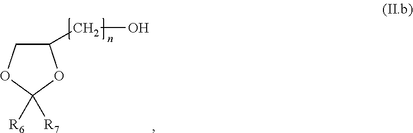

wherein R₆ and R₇ individually comprises a hydrogen, an alkyl group, an alkenyl group, or a phenyl group, wherein n is an integer of from 1 to 10.

In one embodiment the composition comprises, by weight of composition, greater than 40 pbw of neem/neem oil (or NBPT in combination with neem/neem oil), the remainder being solvent or a mixture of solvents.

In one embodiment the composition comprises, by weight of composition, greater than 35 pbw of neem/neem oil (or NBPT in combination with neem/neem oil), the remainder being solvent or a mixture of solvents.

In one embodiment the composition comprises, by weight of composition, greater than 45 pbw of neem/neem oil and/or NBPT, the remainder being solvent or a mixture of solvents. By way of example, in one embodiment, the fertilizer composition comprises, by weight of composition, 45 wt % of neem/neem oil and 55 wt % of a solvent blend of: (i) DMSO; and (ii) at least one stabilizer as described herein.

In one embodiment the composition comprises, by weight of composition, greater than 55 pbw of neem/neem oil and/or NBPT, the remainder being solvent or a mixture of solvents. By way of example, in one embodiment, the fertilizer composition comprises, by weight of composition, 55 wt % of neem/neem oil and 45 wt % of a solvent blend of: (i) at least one dioxolane compound of formula (II.b) or formula (II.a), wherein R₆ and R₇ are as described above; and

(ii) at least one stabilizer as described herein.

### EXAMPLES

Referring to Tables 1-5, NBPT active was melted (melting point NBPT is 58-60° C.) along with identified surfactant having a melting point range of 55-75° C. Both the NBPT and identified surfactant component were melted, and neem oil was slowly added to the mixture. When the solutions come to room temperature they were observed to form a paste.

TABLE I

| % Composition | | | | |
|---|---|---|---|---|
| | stearic | | | |
| | acid, | | | |
| | monoester | | | |
| | with | | Product | Product when kept |
| | glycerol | Neem | observation | standing at 75° C. |
| NBPT | glycerol | Seed Oil | at 30° C. | for 10 mins |
| 47.5 | 5 | 47.5 | Stable paste | Neem oil & NBPT |
| | | | | separates |
| 45 | 10 | 45 | Stable paste | Neem oil & NBPT |
| | | | | separates |

TABLE 2

| % Composition | | | Product | Product when kept |
|---|---|---|---|---|
| | Glycol | Neem | observation | standing at 75° C. |
| NBPT | Stearate | Seed Oil | at 30° C. | for 10 mins |
| 47.5 | 5 | 47.5 | Stable paste | Neem oil & NBPT |
| | | | | separates |
| 45 | 10 | 45 | Stable paste | Neem oil & NBPT |
| | | | | separates |

TABLE 3

| % Composition | | | | |
|---|---|---|---|---|
| | Ethylene | | Product | Product when kept |
| | Glycol | Neem | observation | standing at 75° C. |
| NBPT | Distearate | Seed Oil | at 30° C. | for 10 mins |
| 47.5 | 5 | 47.5 | Stable paste | Neem oil & NBPT |
| | | | | separates |
| 45 | 10 | 45 | Stable paste | Neem oil & NBPT |
| | | | | separates |

TABLE 4

| % Composition | | | Product | Product when kept |
|---|---|---|---|---|
| | Cocoamide | Neem | observation | standing at 75° C. |
| NBPT | MEA | Seed Oil | at 30° C. | for 10 mins |
| 47.5 | 5 | 47.5 | Stable paste | Neem oil & NBPT |
| | | | | separates |
| 45 | 10 | 45 | Stable paste | Neem oil & NBPT |
| | | | | separates |

TABLE 5

| % Composition | | | Product | Product when kept |
|---|---|---|---|---|
| | PEG | Neem | observation | standing at 75° C. |
| NBPT | distearate | Seed Oil | at 30° C. | for 10 mins |
| 47.5 | 5 | 47.5 | Stable paste | Neem oil & NBPT |
| | | | | separates |
| 45 | 10 | 45 | Stable paste | Neem oil & NBPT |
| | | | | separates |

It should be apparent embodiments other than those expressly described above come within the spirit and scope of the present invention. Thus, the present invention is not defined by the above description but by the claims appended hereto.

What is claimed is:

1. A stable liquid agricultural composition comprising
at least one nitrification inhibitor comprising neem oil;
at least one solvent selected from:
(a) at least one dioxolane compound of formula (I.b): 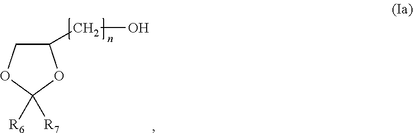
wherein R₆ and R₇ individually comprises a hydrogen, an alkyl group, an alkenyl group, or a phenyl group, wherein n is an integer of from 1 to 10; b) at least one dibasic ester; c) at least one compound of formula (III):
R₃OOC-A-CONR₄R₅ (III),
wherein R₃ comprises a C₁—C₃₆ alkyl group; wherein R₄ and R₅ individually comprise a C₁—C₃₆ alkyl group, wherein R₄ and R₅ can optionally together form a ring; and wherein A is a linear or a branched divalent C₂—C₆ alkyl group; d) at least one alkyldimethylamide; e) at least one alkyl lactate; f) ethyl levulinate; g) at least one alkyoxyalcohol, ether alcohol, amine alcohol, amino alcohol or alcohol; h) at least one glycol, glycol derivative, glycerine or glycerine derivative; i) at least one alkylene carbonate; j) dimethylsulfoxide; k) an amine selected from monoalkanolamine, dialkanolamine, trialkanolamine, monoethanolamine, diethanolamine and triethanolamine; I) a sulfone or sulfolane; m) an aminoalkoxy alcohol; n) cyclohexanone or cyclopentanone; o) benzyl alcohol; or p) any combination thereof,
wherein the at least one nitrification inhibitor is dispersed or solubilized in the at least one solvent.

2. The agricultural composition of claim 1 further comprising at least one urease inhibitor, wherein the at least one nitrification inhibitor and the at least one urease inhibitor are dispersed or solubilized in the at least one solvent.

3. The liquid agricultural composition of claim 1 wherein the at least one solvent comprises:
dimethylsulfoxide, and
a co-solvent selected from:
a) at least one dioxolane compound of formula (I.b): 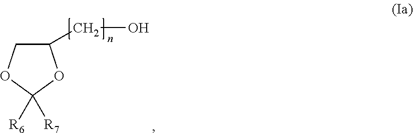
wherein R₆ and R₇ individually comprises a hydrogen, an alkyl group, an alkenyl group, or a phenyl group, wherein n is an integer of from 1 to 10; b) at least one dibasic ester; c) at least one compound of formula (III):
R₃OOOC-A-CONR₄R₅ (III),
wherein R₃ comprises a C₁—C₃₆ alkyl group; wherein R₄ and R₅ individually comprise a C₁—C₃₆ alkyl group, wherein R₄ and R₅ can optionally together form a ring; and wherein A is a linear or a branched divalent C₂—C₆ alkyl group; d) at least one alkyldimethylamide; e) at least one alkyl lactate; f) ethyl levulinate; g) at least one alkyoxyalcohol, ether alcohol, amine alcohol, amino alcohol or alcohol; h) at least one glycol, glycol derivative, glycerine or glycerine derivative; i) at least one alkylene carbonate; j) sulfone or sulfolane; k) an amine selected from monoalkanolamine, dialkanolamine, trialkanolamine, monoethanolamine, diethanolamine and triethanolamine; l) an aminoalkoxy alcohol; m) cyclohexanone or cyclopentanone; n) benzyl alcohol; or o) any combination thereof.

4. The liquid agricultural composition of claim 1 wherein the composition comprises:
neem oil;
dimethylsulfoxide; and
an amine selected from monoalkanolamine, dialkanolamine, trialkanolamine, monoethanolamine, diethanolamine, triethanolamine or any combination thereof.

5. The liquid agricultural composition of claim 1 wherein the at least one nitrification inhibitor is present in an amount less than about 75 wt %, by total weight of composition.

6. The liquid agricultural composition of claim 1 wherein the at least one nitrification inhibitor is present in an amount less than about 65 wt %, by total weight of composition.

7. The liquid agricultural composition of claim 1 wherein the at least one nitrification inhibitor is present in an amount less than about 50 wt %, by total weight of composition.

8. The liquid agricultural composition of claim 1 further comprising a compound of formula (I.a): 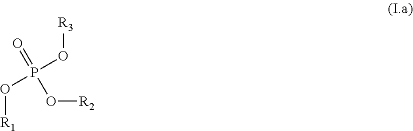
wherein R₁, R₂ and R₃, are each independently chosen from a C₁—C₁₆ alkyl group, a C₁—C₁₆ alkenyl, group, a C₁—C₁₆ alkoxyalkyl group, a C₇—C₃₀ alkylarylalkyl group, a C₇—C₃₀ arylalkyl group, or an aryl group.

9. A method of making a solid or concentrated liquid fertilizer composition comprising contacting one or more nitrogenous fertilizer compounds with a liquid inhibitor composition that comprises at least one nitrification inhibitor comprising neem oil, which is solubilized in a liquid medium comprising
at least one solvent selected from:
(a) at least one dioxolane compound of formula (I.b): 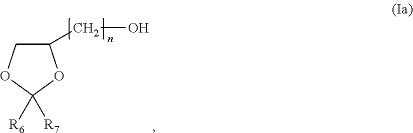
wherein R₆ and R₇ individually comprises a hydrogen, an alkyl group, an alkenyl group, or a phenyl group, wherein n is an integer of from 1 to 10; b) at least one dibasic ester; c) at least one compound of formula (III):
R₃OOC-A-CONR₄R₅ (III),
wherein R₃ comprises a C₁—C₃₆ alkyl group; wherein R₄ and R₅ individually comprise a C₁—C₃₆ alkyl group, wherein R₄ and R₅ can optionally together form a ring; and wherein A is a linear or a branched divalent C₂—C₆ alkyl group; d) at least one alkyldimethylamide; e) at least one alkyl lactate; f) ethyl levulinate; g) at least one alkyoxyalcohol, ether alcohol, amine alcohol, amino alcohol or alcohol; h) at least one glycol, glycol derivative, glycerine or glycerine derivative; i) at least one alkylene carbonate; j) dimethylsulfoxide; k) an amine selected from monoalkanolamine, dialkanolamine, trialkanolamine, monoethanolamine, diethanolamine and triethanolamine; l) a sulfone or sulfolane; m) an aminoalkoxy alcohol; n) cyclohexanone or cyclopentanone; o) benzyl alcohol; or p) any combination thereof.

10. The method of claim 9 wherein the at least one solvent comprises
dimethylsulfoxide, and
a co-solvent selected from:
a) at least one dioxolane compound of formula (I.b): 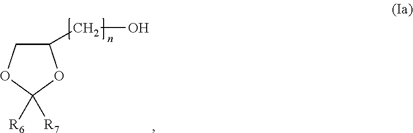
wherein R₆ and R₇ individually comprises a hydrogen, an alkyl group, an alkenyl group, or a phenyl group, wherein n is an integer of from 1 to 10; b) at least one dibasic ester; c) at least one compound of formula (III):
R₃OOC-A-CONR₄R₅ (III),
wherein R₃ comprises a C₁—C₃₆ alkyl group; wherein R₄ and R₅ individually comprise a C₁—C₃₆ alkyl group, wherein R₄ and R₅ can optionally together form a ring; and wherein A is a linear or a branched divalent C₂—C₆ alkyl group; d) at least one alkyldimethylamide; e) at least one alkyl lactate; f) ethyl levulinate; g) at least one alkyoxyalcohol, ether alcohol, amine alcohol, amino alcohol or alcohol; h) at least one glycol, glycol derivative, glycerine or glycerine derivative; i) at least one alkylene carbonate; j) sulfone or sulfolane; k) an amine selected from monoalkanolamine, dialkanolamine, trialkanolamine, monoethanolamine, diethanolamine and triethanolamine; l) an aminoalkoxy alcohol; m) cyclohexanone or cyclopentanone; n) benzyl alcohol; or o) any combination thereof.

11. A concentrated liquid fertilizer composition comprising, based on 100 parts by weight of the composition:
from about 5 to about 80 parts by weight of one or more nitrogenous fertilizer compounds,
at least one urease inhibitor or at least one nitrification inhibitor; and
at least one solvent,
wherein the at least one nitrification inhibitor or the at least one urease inhibitor is dispersed or solubilized in the at least one solvent, and wherein the at least one nitrification inhibitor is selected from neem, neem oil, neem cake, koronivia grass, karanj, karanjin seed extract, karanj oil, mahua, mahua oil, castor, castor oil, mint, mint oil, or any combination thereof.

12. The concentrated liquid fertilizer composition of claim 11 wherein the at least one nitrification inhibitor is neem or neem oil.

13. The concentrated liquid fertilizer composition of claim 11 wherein the at least one solvent comprises:
(a) at least one dioxolane compound of formula (I.b): 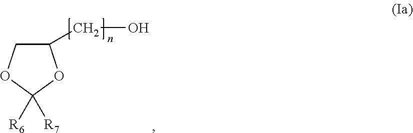
wherein R₆ and R₇ individually comprises a hydrogen, an alkyl group, an alkenyl group, or a phenyl group, wherein n is an integer of from 1 to 10; b) at least one dibasic ester; c) at least one compound of formula (III):
R₃OOC-A-CONR₄R₅ (III),
wherein R₃ comprises a C₁—C₃₆ alkyl group; wherein R₄ and R₅ individually comprise a C₁—C₃₆ alkyl group, wherein R₄ and R₅ can optionally together form a ring; and wherein A is a linear or a branched divalent C₂—C₆ alkyl group; d) at least one alkyldimethylamide; e) at least one alkyl lactate; f) ethyl levulinate; g) at least one alkyoxyalcohol, ether alcohol, amine alcohol, amino alcohol or alcohol; h) at least one glycol, glycol derivative, glycerine or glycerine derivative; i) at least one alkylene carbonate; j) dimethylsulfoxide; k) an amine selected from monoalkanolamine, dialkanolamine, trialkanolamine, monoethanolamine, diethanolamine and triethanolamine; I) a sulfone or sulfolane; m) an aminoalkoxy alcohol; n) cyclohexanone or cyclopentanone; o) benzyl alcohol; or p) any combination thereof.

14. The concentrated liquid fertilizer composition of claim 11 wherein the at least one solvent comprises dimethylsulfoxide.
